(19) United States
(12) Patent Application Publication
(10) Pub. No.: US 2008/0202931 A1
(43) Pub. Date: Aug. 28, 2008

(54) Ion Specific Control of the Transport of Fluid and Current in Fluidic Nanochannels

(76) Inventors: Dimiter Nikolov Petsev, Albuquerque, NM (US); Zhen Yuan, Albuquerque, NM (US)

Correspondence Address: GONZALES PATENT SERVICES, 4605 CONGRESS AVE. NW, ALBUQUERQUE, NM, 87114, US

(21) Appl. No.: 11/763,563

(22) Filed: Jun. 15, 2007

Related U.S. Application Data
(60) Provisional application No. 60/813,841, filed on Jun. 15, 2006.

(51) Int. Cl. G01N 27/26

(52) U.S. Cl. 204/451; 204/601

(57) ABSTRACT

The present disclosure provides various means for optimizing fluid transport in micro and nanofluidic devices. Such means may be used to construct fluidic devices specifically suited to particular tasks such as molecular and biomolecular sensing and analysis, biosensors for clinical diagnostics; memory devices; screening devices for pharmaceutical applications; the provision of biologically functionalized surfaces; high throughput screening for pharmaceutical applications; controlled drug delivery; medical diagnosis; environmental monitoring; chemical and biological warfare agent sequestration; actuator development; power sources; transistors; diodes; electrochemical pumps; and bio-fuel cell development. The present disclosure further provides methods of controlling the direction of electric current and fluid flow in such devices.

### CROSS-REFERENCE TO RELATED APPLICATIONS

The following application claims benefit of U.S. Provisional Application No. 60/813,841, filed Jun. 15, 2006, which is hereby incorporated by reference in its entirety.

### STATEMENT REGARDING GOVERNMENT SPONSORED

Aspects of this work were supported by a grant from the National Science Foundation through Grant No. CTS 0404124. The United States Government has certain rights in the subject matter.

### TECHNICAL FIELD

The present invention relates to nanotechnology. More specifically, the present invention relates to methods of controlling the flow of fluids and current in nanostructured or nanofluidic devices.

### BACKGROUND

Interest in microfabricated devices has grown substantially over the past decade as technology has made it possible to create increasingly small and complex items. Such devices, including nanofabricated devices, have numerous advantages. They are particularly useful for manipulating small sample volumes and integrating sample pretreatment and separation strategies. Additionally, micro- and nanodevices including fluidic devices have high surface-to-volume ratios allowing for rapid processing of samples. These devices may incorporate elements such as filters, valves, pumps, mixers, reactors, separation columns, cytometers and detectors, creating a lab-on-a-chip and allowing for enhanced analyses and sensing of small volumes of items of interest.

Miniaturized devices such as microfluidic or nanofluidic structures are used for a variety of purposes such as molecular and biomolecular sensing and analysis; biosensors for clinical diagnostics; memory devices; screening devices for pharmaceutical applications; the provision of biologically functionalized surfaces; high throughput screening for pharmaceutical applications; controlled drug delivery; medical diagnosis; environmental monitoring; chemical and biological warfare agent sequestration; actuator development; power sources; transistors; diodes; electrochemical pumps; analysis of biopolymers, such as DNA and proteins, synthetic polymers; simulation of processes in biological systems such as transmembrane receptors; performance of single-molecule chemical reactions; fabrication of nanoscale components by mechanical or molecular assembly; and bio-fuel cell development.

Micro- or nanofluidic devices are generally composed of a series of channels or other features on a planar surface area such as a chip. The transport of fluids along channels and between reservoirs in a micro- or nanofluidic device may be accomplished by a variety of means including capillary action, electroosmotic flow, electric conductivity, and electrophoresis. Many of the advantages of using micro- or nanofluidic devices rely on the high amount of surface interaction per unit volume of the solute. However, the small size of the channels used in transporting solutes in these devices creates some unique problems such as unexpected changes in conductivity and other electrokinetic interactions. Additionally, the transport of fluids and analytes in a micro- or nanofluidic device may be affected by multiple design features making it difficult to design appropriate micro- or nanofluidic devices capable of specific fluid interactions and transport.

At the nanometer scale, the physics of fluid interaction and transport differs from that at larger scales. For example, in nanostructured devices, the electric double layers at the channel wall may overlap. This overlapping affects conductivity and flow of fluids through nanochannels making it difficult to predict the migration of conductivity and its effect on fluid flow through the nanochannels. The overlapping electric double layers may also affect ionic distribution. Transport through nanochannels may be further affected by the close proximity of the channel wall surfaces, which may alter the fluid velocity profile and distribution of the analytes.

Previous research into the electroosmotic flow in nanofluidic devices has been limited to the use of solutions of symmetric electrolytes as a transportation medium. There therefore exists a need for methods that analyze the full effects of the unique properties of micro- and nanofluidic devices, transport media used in such devices and the analytes that may be transported in the transport media. Such methods may be used to control the flow of fluids and analytes and current in micro- and nanofluidic devices as well as for the creation of optimal micro- and nanofluidic devices for the transport and analysis of specific solutions.

### BRIEF DESCRIPTION OF THE DRAWINGS

FIG. 1 is a schematic representation of a fluidic channel which would permit the application of a transverse voltage bias at the walls. (not to scale)

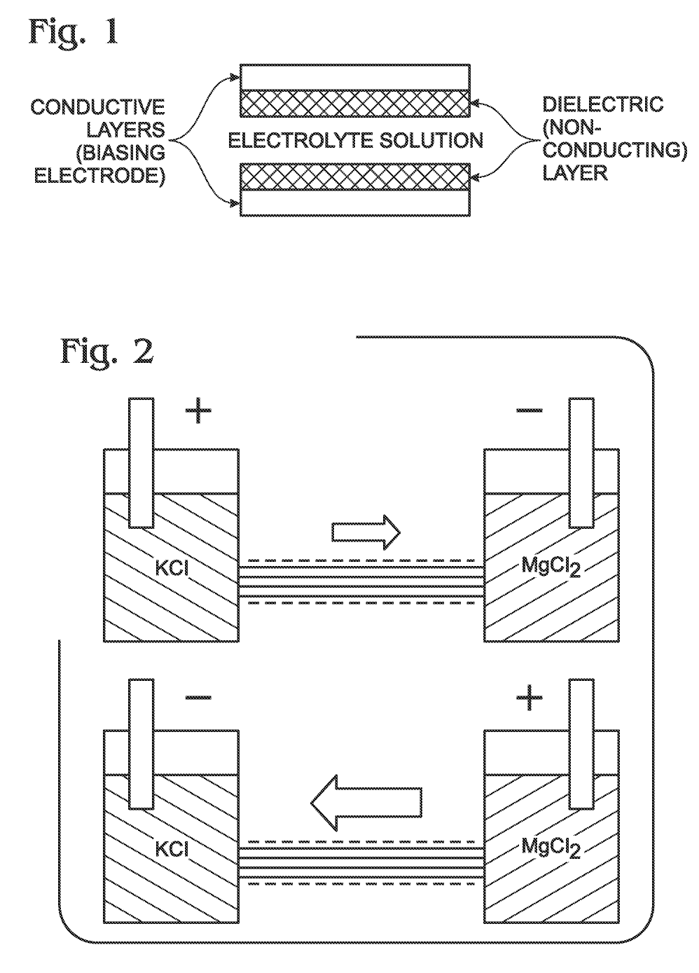

FIG. 2 is a diagram showing an electrolyte dependent current in a negatively charged nanochannel.

FIG. 3 is two graphs showing the conductivity of parallel slit shaped fluidic channels filled with KCl solution vs. width with (A) depicting the migration contribution and (B) depicting the convective contribution. The curves correspond, (top to bottom) to [symbol] 4, [symbol] 3, [symbol] 2 and [symbol] 1

FIG. 4 is a pair of graphs showing the conductivity of parallel slit shaped fluidic channels filled with MgCl₂ solution vs. width (A) depicting the migration contribution and (B) depicting the convective contribution. The curves correspond, (top to bottom) to [symbol] 4, [symbol] 3, [symbol] 2 and [symbol] 1

FIG. 5 is a series of graphs showing the effect of the transverse voltage bias \tilde{Φ}_{δ} on the resulting electrokinetic ξ potential (in e/kT) where κδ=2-20 for (a) symmetric (1:1) electrolyte, (b) symmetric (2:2) electrolyte, (c) asymmetric (2:1) electrolyte, and (d) asymmetric (1:2) electrolyte.

FIG. 6 is a graph showing the net fluid flow [symbol] in one direction under the action of the external alternate current field E. The curves from top to bottom correspond to electric potential [symbol] where: [symbol] −5, −4, −3, −2, −1. [symbol] ez/kT, kT/e≈26 mV.

FIG. 7 is a graph showing the conductivity of a cylindrically shaped fluid channel filed with KCl solution vs. radius of the channel taking into consideration the (a) migration contribution and (b) convective contribution. The different curves correspond (top to bottom) to [symbol] 4, [symbol] 3, [symbol] 2 and [symbol] 1.

### DETAILED DESCRIPTION

The present invention provides means for obtaining analytical expressions for the transport of fluid, ions, and analytes in micro and nanostructured devices, specifically microfluidic and nanofluidic devices.

The present invention further provides means for obtaining numerical expressions for the transport of fluid, ions, and analytes in micro and nanostructured devices, specifically microfluidic and nanofluidic devices.

The present invention additionally provides optimal sizes and configurations of micro and nanofluidic devices based on the fluid and/or analyte to be transported.

The present invention further provides means for controlling the direction of electric current and fluid flow in micro and nanofluidic devices.

The present invention additionally provides means for determining optimal structures for the transport of symmetric and asymmetric electrolytes using various micro- and nanoscale channels and capillaries.

The size of the micro- and nanofluidic devices of the present invention makes them suitable for use in a wide variety of applications. Such devices may be tailored to specific transport solutions as well as to the analytes being processed. Exemplary uses of such devices include, but are not limited to, biomolecular sensing and analysis, biosensors for clinical diagnostics; memory devices; screening devices for pharmaceutical applications; the provision of biologically functionalized surfaces; high throughput screening for pharmaceutical applications; controlled drug delivery; medical diagnosis; environmental monitoring; chemical and biological warfare agent sequestration; actuator development; power sources; transistors; diodes; electrochemical pumps; analysis of biopolymers, such as DNA and proteins, synthetic polymers; simulation of processes in biological systems such as transmembrane receptors; performance of single-molecule chemical reactions and fabrication of nanoscale components by mechanical or molecular assembly; and bio-fuel cell development.

Due in part to the size of nano- and microfluidic devices, electrokinetic phenomena play a significant role in the transport of fluids, ions, current and analyte within the channels of the device. For example, the size of the electric double layer at the channel wall plays a greater role in nano- and microfluidic devices than in larger devices in part due to the amount of the channel that may be occupied by the double layer. Additionally, in nanofluidic devices, the electric double layer may overlap further complicating the electrokinetic phenomena in such devices.

Transport of fluids in nano- and microfluidic devices is governed in part by the potential and charge at the channel wall/solution interface. This interfacial potential is referred to as the ζ-potential.

The ζ-potential may be manipulated by several means including, but not limited to, changing the current in a channel; applying a transverse voltage bias across the channel wall; using multiple fields; phasing different fields; modulating the electric double layer at the wall of the channel; altering the width of the electric double layer at the wall of the channel; altering the fluid at either end of the channel, for example increasing or decreasing the concentration or type of electrolytes or analytes; altering the shape of the channel; altering the width of the channel; and altering the composition of the device.

The current in a micro- or nanochannel depends in part on the local concentration of ions. In narrow channels, the local concentration of counterions depends on the electrostatic potential and exceeds that of a bulk solution. Generally, the local concentration is in thermodynamic equilibrium with the overlapping electric double layers at the channel walls leading to an increase of the conductivity of the electrolyte solution in the channel. For example, the electrostatic potential distribution in a nanochannel filled with electrolyte solution A, is given by the Poisson-Boltzmann equation which for a binary (z₁:z₂) electrolyte reads:

$$\begin{matrix}{∇}^{2} \tilde{Ψ} = - \frac{{κ}^{2}}{{z}_{1} + {z}_{2}} [ exp ( - {z}_{1} \tilde{Ψ} ) - exp ( {z}_{2} \tilde{Ψ} ) ] , \tilde{Ψ} = \frac{e Ψ}{kT} \\ where & ( 1 ) \\ {κ}^{2} = \frac{{e}^{2} ( {z}_{1}^{2} {n}_{1} + {z}_{2}^{2} {n}_{2} )}{{ɛɛ}_{0} kT} & ( 2 )\end{matrix}$$

defines the inverse thickness of the double layer (i.e. screening parameter); e is the elementary charge, kT is the thermal energy, ∈ and ∈₀ are the relative dielectric permittivity (78.25 for water at 25° C.) and the dielectric constant of vacuum (8.854×10⁻¹²C²J⁻¹m⁻¹) respectively and n₁ and n₂ are the number concentrations of the ionic species in the binary electrolyte. The boundary conditions of the channel in the above equation are Ψ=ζ for the channel wall and ∇ψ=0 in the center of the channel.

For the determination of the electrostatic potential distribution in a nanochannel filled with asymmetric electrolyte solution ψ, including, but not limited to, electrolytes in valence ratios of 2:1 or 1:2 the following functions need to be introduced:

$$\begin{matrix}{f}_{1} ( {\tilde{Ψ}}_{1} ) = ln ⌊ \frac{2 exp ( {\tilde{Ψ}}_{1} ) + 1}{3} ⌋ , \vert {z}_{1} \vert = 2 , \vert {z}_{2} \vert = 1 , \\ and & ( 3 ) \\ {f}_{2} ( {\tilde{Ψ}}_{1} ) = ln [ \frac{3}{1 + 2 exp ( - {\tilde{Ψ}}_{1} )} ] , \vert {z}_{1} \vert = 1 , \vert {z}_{2} \vert = 2. & ( 4 )\end{matrix}$$

Equation 1 would therefore become:

$$\frac{d {}_{}^{2}{f}{}_{i}^{}}{d {x}^{2}} = {κ}^{2} sinh ( {f}_{i} ) , i = 1 , 2. \\ {\tilde{Ψ}}_{1} ( 0 ) = {\tilde{Ψ}}_{0} and {\tilde{Ψ}}_{1} ( ∞ ) = 0 \qquad ( 5 )$$

When equation 5 is solved using the boundary conditions the solution becomes:

$${f}_{i} ( {\tilde{Ψ}}_{1} ) = 4 arctan h \{ tanh [ \frac{{f}_{i} ( {\tilde{Ψ}}_{0} )}{4} ] exp ( - κ x ) \} , i = 1 , 2. \qquad ( 6 )$$

where ψ̅ is the potential at the surface and is assumed to coincide with the electrokinetic ζ potential.

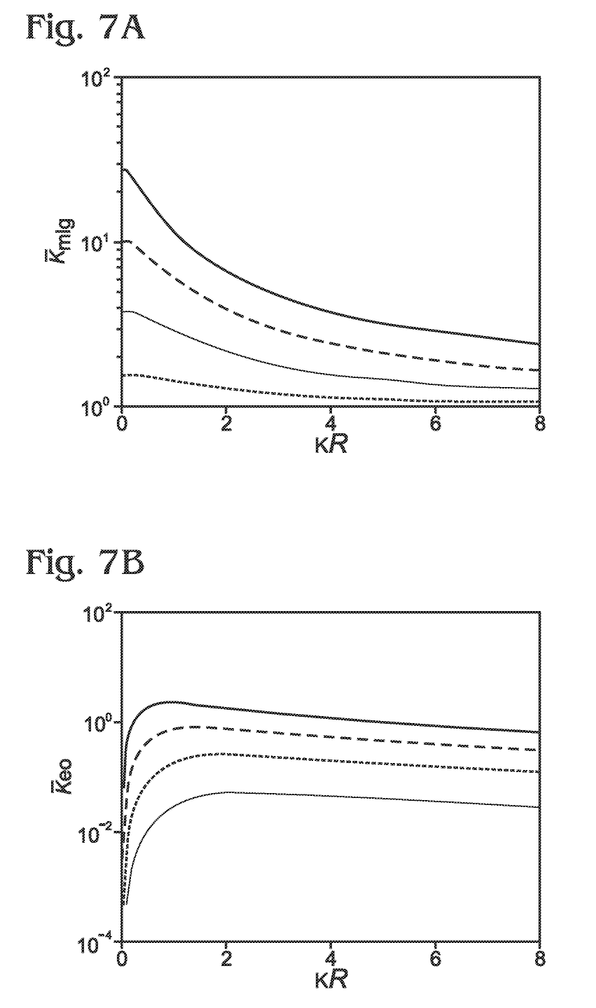

The electrostatic potential distribution is also affected by the shape of the channel. This effect is reflected in the second order differential operator in equation (1). Channels may be of any shape or size generally used in micro- and nanofluidic devices. In some embodiments the channels may be parallel planar slits. In such an embodiment, ∇²=d²/dx². In another embodiment, the channels may be cylindrical capillaries. In such an embodiment, ∇²=d²/dr²+(1/r)d/dr. As can be seen in FIG. 7, cylindrical capillaries are more efficient in conducting electrical current than parallel slits.

In other embodiments, the channels may be troughs, holes, wells, pores, or a combination thereof. In further embodiments, the channels may be rectangular. These channels may be arranged in a regular array or in an asymmetric manner. In some embodiments, the channels may be of different sizes. In other embodiments, the channels may be of uniform size. In further embodiments, the channels may be parallel. Such channels may have homogeneous or varied widths. In one embodiment, the widths of the channels may vary from about 10 to about 1000 nm, preferably from about 35 to about 500 nm, more preferably from about 40 to about 200 nm. The computations used in the present invention determined that as the channel becomes thinner, the migration contribution monotonically increases while the convective term due to the electroosmotic flow passes through a maximum and then sharply decreases.

Channels may additionally have homogeneous or varied depths. In additional embodiments, the spacing between the channels may be uniform or varied. The spacing may be of any distance such that the channels do not communicate fluidically or electrically. In some embodiments, the channels may be from about 10 nm to about 600 nm apart, more preferably from about 100 nm to about 500 nm apart, more preferably from about 250 nm to about 425 nm apart, more preferably from about 300 nm to about 350 nm apart. Predictions and designs according to embodiments of the present invention may be based on some or all of the channels on a micro- or nanofluidic device.

The electrokinetic interactions of micro- and nanofluidic devices may also be influenced by the length of the channels. In some embodiments, the channels are about 0.01 cm to about 1 cm, preferably about 0.01 to about 0.2 cm, preferably about 0.01 to about 0.05 cm in length. In some embodiments, channels of about or below 500 μm may be preferred when used in conjunction with an insulating SiO layer having a thickness of 100 nm. However it will be appreciated that channels of greater lengths may be used, for example, though not necessarily, in conjunction with a more insulating layer (for example, a thicker insulating layer or a layer formed from one or more material which alone or in combination have greater insulating properties).

The ζ-potential may also be influenced by the thickness of the electric double layer at the walls of the channel. In some embodiments, the double layer thickness may depend on the transportation medium. For example, for electrolyte concentrations of symmetric monovalent electrolytes, in concentrations of between 10⁻⁶ and 10⁻⁴ M, the double layer thickness may vary from about 300 to 1 nm, preferably from about 200 to 3 nm, more preferably from about 30 to about 3 nm. In another embodiment, for a 50 nm wide channel, the background electrolyte concentration should be no less than 6×10⁻⁴ M. In some embodiments, the nanochannel width, h, may be greater than the thickness of the electric double layer. The nanochannel width may be equivalent, two, three, four, five or more times greater than the thickness of the electric double layer.

Nanofluidic devices may additionally be created to take into consideration the particular analytes to be transported. The analyte may be charged or uncharged, positive or negative. In some embodiments, the analyte may be in or may be put in an electrolyte solution.

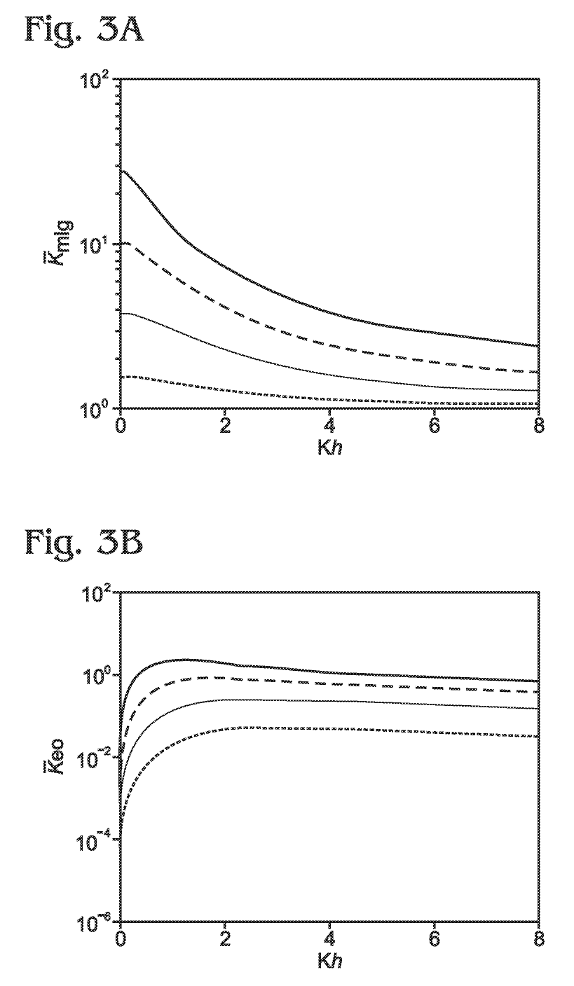

Electrolytes in solutions used, for example, as transportation media, may be monovalent, divalent, trivalent, symmetric or asymmetric. Exemplary electrolytes for use in the present invention include, but are not limited to, KCL, MgCl₂, K₂SO₄, AlCl₃, Al₂(SO₄)₃, BaCl₂, CaCl₂, CdCl₂, CdSO₄, CoCl₂, CoSO₄, CrCl₃, Cr₂(SO₄)₃, CuCl₂, CuSO₄, FeCl₂, FeSO₄, FeCl₃, Fe₂(SO₄)₃, HCl, HCN, HNO₃, H₃PO₄, H₂SO₄, K₂CO₃, KNO₃, KOH, LiCl, Li₂SO₄, MgSO₄, MnCl₂, MnSO₄, NaBr, NaCl, NaClO₃, Na₂CO₃, NaF, NaHCO₃, NaH₂PO₄, Na₂HPO₄, NaHSO₃, NaI, Na₂MoO₄, NaNO₂, NaNO₃, NaOH, Na₃PO₄, Na₂SO₃, Na₂S₂O₃, Na₂SO₄, NH₃, NH₄Cl, NH₄NO₃, (NH₄)₂SO₄, NiCl₂, NiSO₄, SrCl₂, ZnCl₂, and ZnSO₄ In some embodiments, the asymmetry of the electrolytes may be 2:1. In other embodiments, the asymmetry of the electrolytes may be 1:2. In further embodiments, the asymmetry may be 3:1. Reservoirs containing electrolytes and/or analytes may be located at either end of the channels in the micro- or nanofluidic devices. In some embodiments, the solutions at either end may be the same. In other embodiments, the solutions at either end of the channel may be different. In some embodiments, if the different solutions at either ends of the channels have different valences, the micro- or nanofluidic device may function as a diode allowing for different current passing in different directions depending on the ions entering the channel (see FIG. 2). In further embodiments, the ionic strength of the two solutions may be the same or different.

Based on Boltzmann's law, it follows that electrolytes with divalent counterions exhibit a stronger attraction in the electric double layers compared to electrolytes with monovalent counterions such that:

$$n = {n}_{0} exp \frac{ze Ψ}{kT} \qquad ( 7 )$$

where n is the local number concentration of counterions, n₀ is the concentration of ions far from the double layer, z is the counterion valency, e is the elementary charge, ψ is the potential of the double layer and kT is the thermal energy.

Consequently, if a nano or microchannel connects two reservoirs filled with different electrolytes, the electric current and electroosmotic fluid flow may differ depending on the direction of the applied field and the counterions that predominantly enter the channel. For example, using an asymmetric 2:1 electrolyte such as MgCl₂, substantially increases both the migration and electroosmotic terms.

The equations above may be used to determine the appropriate structure of the nanofluidic device to achieve a particular result including, but not limited to, the transport of a particular analyte. The screening parameter κ as used in equation (2) is defined by the electrolyte concentration of a macroscopic bulk reservoir in fluidic contact and thermodynamic equilibrium with the channels. The total conductivity of a fluidic nanochannel consists of migration of a term:

$$\begin{matrix}{K}_{mig} = \frac{{j}_{mig}}{E} \\ = \frac{{e}^{2}}{AkT} {\int }_{A} \{ {z}_{1}^{2} {D}_{1} {n}_{1}^{0} exp [ - {z}_{1} \tilde{Ψ} ( r ) ] + {z}_{2}^{2} {D}_{2} {n}_{2}^{0} exp [ - {z}_{2} \tilde{Ψ} ( r ) ] \} d A\end{matrix} \qquad ( 8 )$$

where A is the area of the channel cross-section, and a convective electroosmotic term, which is due to the counterion excess (charge density ρₑ) in the double layer carried by the electroosmotic fluid flow:

$${K}_{eo} = \frac{{j}_{eo}}{E} = \frac{1}{A} {\int }_{A} {ρ}_{e} ( r ) \frac{{ɛɛ}_{0} [ Ψ ( r ) - Ϛ ]}{η} d A \qquad ( 9 )$$

and j_{mig} and jₑₒ are the respective migration and electroosmotic convective contribution to the total current density due to the applied field E. The charge density is:

ρₑ(r)=e{zᵢnᵢ⁰exp[−z₁ψ(r)]−z₂n₂⁰exp[z₂ψ(r)]}. (10)

Dᵢ are the diffusion coefficients of the ionic species, and nᵢ⁰ are their concentrations in the bulk reservoir that is in contact with the channel and η is the solvent viscosity.

The fluid flow that leads to the convective transport of ions is given by:

$$η {∇}^{2} v = ( {ɛɛ}_{0} {∇}^{2} Ψ ) E \qquad ( 11 )$$

where v is the velocity profile and E is the electric field vector. Assuming that the boundary conditions are v=0 and ψ=ζ the solution for the fluid flow velocity is therefore:

$$v ( r ) = \frac{{ɛɛ}_{0}}{η} [ Ψ ( r ) - Ϛ ] \qquad ( 12 )$$

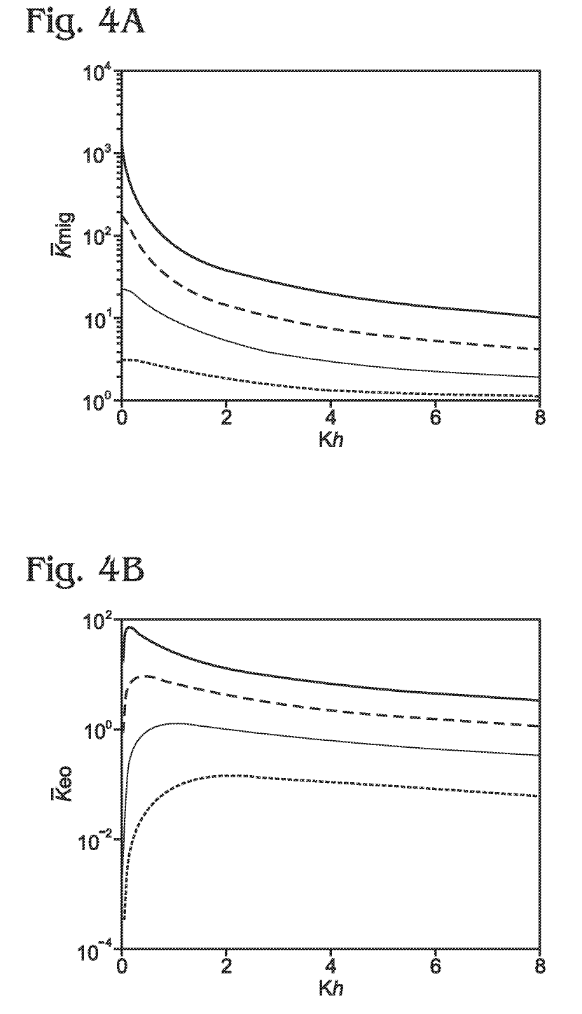

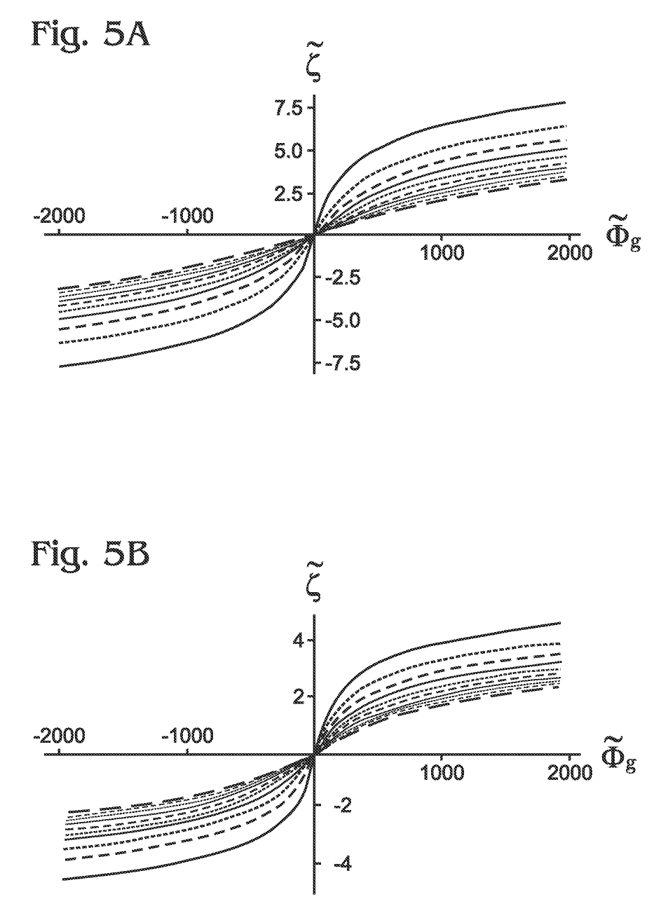

The dependence of the relative migration conductivity ( K̅_{mig} [symbol] K_{mig}/K_{mig}⁰) for a KCl solution using a parallel slit-shaped fluidic nanochannel with dimensionless width kh is shown in FIG. 3. FIG. 3 shows the relative conductivity in the channels with respect to that of the bulk solution in the reservoir that is in thermodynamic equilibrium with double layers K⁰_{mig}. As seen in FIG. 4, the use of asymmetric electrolytes such as MgCl₂ substantially increases both the migration and electroosmotic terms even if the ionic strength remains the same. Additionally, the relative conductivity decreases with the width of the channel, h, and eventually approaches that of the solution in the reservoirs for h→∞. Decreasing the electrolyte concentration has the same effect as increasing the relative conductivity.

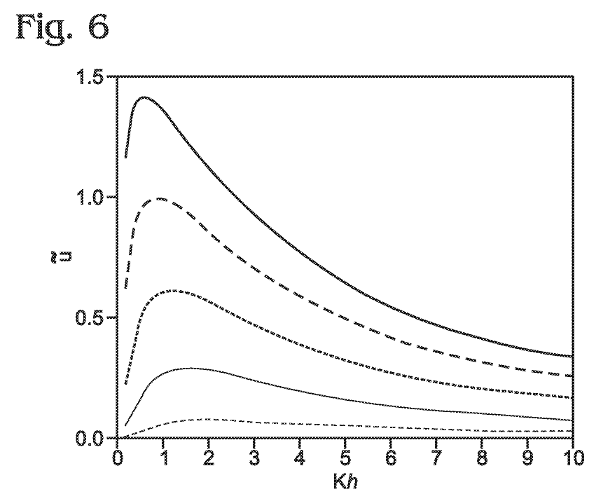

The effect of electric potential on fluid flow can be seen in FIG. 6, which shows the net fluid flow in one direction under the action of the external alternate current field. Due to the different ions alternately filling the channel with the field the shape of the potential changes and therefore the flow rate in on direction (when Mg²⁺ ions are predominantly in the channel) is greater than in the opposite (K⁺ ions fill the channel.) The effect of electrokinetic potential on fluid flow is shown in the descending curves in FIG. 6 with the curves corresponding to electrokinetic potential [symbol] where [symbol] −5, −4, −3, −2, −1. [symbol] ez/kT, kT/e≈26 mV. For the same ionic strengths, the conductivities for negative ζ potentials are much higher than those for positive ζ potentials.

The average fluid flow rate U for the case depicted in FIG. 6 is calculated using the following formula:

$$\tilde{U} = \frac{Δ U e η}{{ɛɛ}_{0} kT \vert E \vert} \qquad ( 13 )$$

such that:

$${\vec{U}}_{{MgCl}_{2}} - {\overleftarrow{U}}_{KCl} = Δ U = \frac{{ɛɛ}_{0} E}{η h} {\int }_{0}^{h} [ \vec{Ψ} ( x ) - \overleftarrow{Ψ} ( x ) ] d x \qquad ( 14 )$$

Where e is the elementary charge, η is the fluid viscosity, ∈ and ∈₀ are the fluid dielectric permittivity and the dielectric constant of vacuum respectively, h is the channel width, κ is the thickness of the electric double layer formed at the channel wall, kT is the thermal energy, Ψ is the electrostatic potential distribution and ζ is the electrokinetic zeta potential. The conductivity is scaled with that of the bulk solution with the same ionic strength.

Transport of fluids in micro- and nanofluidic devices may further be effected by the application of external voltage. External voltage may be applied, for example, across the channel wall in a transverse voltage. The effect of such external voltage on the ζ potential may be calculated using:

$$Δ ζ {Φ}_{b} - [ {ζ}_{0} + \frac{{σ}_{0} ( {ζ}_{0} + Δζ ) δ}{{ɛ}_{0} {ɛ}_{0}} ] \qquad ( 15 )$$

where Δζ is the shift in the interfacial potential, σ₀ is the surface charge (σ₀ [symbol] ∈∈₀∇Ψ|_{wall}), δ is the thickness of the channel wall, and ∈₀ is the relative dielectric permittivity of the channel wall.

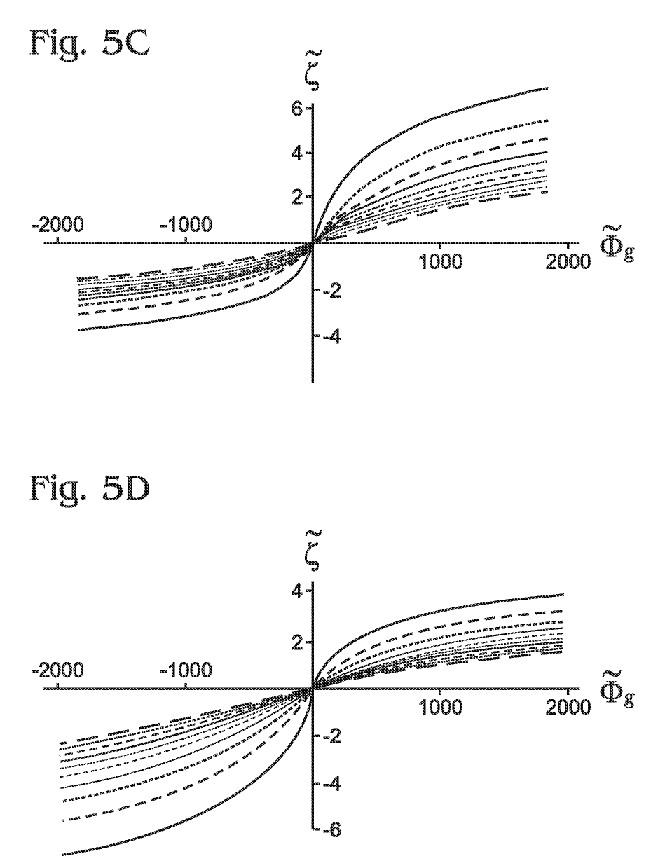

The effect of the application of transverse voltage on the electrokinetic potential ξ is shown in FIG. 5. In FIG. 5, it is assumed that the native potential of the channel wall/solution interface is zero. The results for solutions of electrolytes with valences of 1:1, 2:2, 2:1, and 1:2 and the different thicknesses of the dielectric layer at the channel walls show that the dependence of the ζ potential on the transverse voltage bias is nonlinear. The curves additionally show a trend towards saturation indicating that increasing the transverse voltage bias may not lead to arbitrarily high ζ potential.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims.

As used herein and in the appended claims, the singular forms “a,” “an,” and “the” include plural reference unless the context clearly dictates otherwise. Thus, for example, a reference to “a channel” includes a plurality (for example, a culture or population) of such channels, and so forth.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Although the foregoing invention has been described in detail by way of example for purposes of clarity of understanding, it will be apparent to the artisan that certain changes and modifications may be practiced within the scope of the appended claims which are presented by way of illustration not limitation. In this context it will be understood that this invention is not limited to the particular formulations, process steps, and materials disclosed herein as such formulations, process steps, and materials may vary somewhat. It will also be understood that the terminology employed herein is used for the purpose of describing particular embodiments only, and is not intended to be limiting since the scope of the present invention will be limited only by the appended claims and equivalents thereof. It is further noted that various publications and other reference information have been cited within the foregoing disclosure for economy of description. Each of these references are incorporated herein by reference in its entirety for all purposes. It is noted, however, that the various publications discussed herein are incorporated solely for their disclosure prior to the filing date of the present application, and the inventors reserve the right to antedate such disclosure by virtue of prior invention.

### REFERENCES

(1) Han, J.; Craighead, H. G, Science 2000, 288, 1026.
(2) Saleh, O. A.; Sohn, L. L. Nano Lett 2003, 3, 37.
(3) Chang, H; Kosari, F.; Andreadakis, G.; Alam. M. A.; Vasmatzis, G.; Bashir, R. Nano Lett. 2804, 4, 1551.
(4) Garcia, A.; Ista, L. K.; Petsev, D. N.; O'Brien, M. J.; Bisong, P.; Mammoti, A. A.; Brueck, S. R. J.; Lopez, CG. P. Lab on a Chip 2005.
(5) O'Brien, M. J.; Bisong, P.; Isia, L. K.; Rabinovich, E. M.; Garcia, A. L.; Sibbett, S. S.; Lopez, G. P.; Brueck, S. R. J. J. Vac. Sci. Technol. B 2063, 21, 2941.
(6) Ghowsi, K.; Gale, R. J. J. Chromatography 1991, 559, 95.
(7) Ghowsi, K.; Gale, R. J. Am. Laboratory 1991, 23, 17.
(8) Schafoort, R. B. M.: Schlautmann, S.; Hendrikse, J.; Berg, A. v. d. Science 1999, 286, 942.
(9) Daiguji, H.; Yang, P.; Majumdar, A. Nano Lett. 2004, 4, 137.
(10) Lee, C. S.; Blanchard, W. C.; Wu, C.-T. Anal. Chem. 1990, 62, 1550.
(11) Hayes, M. A.; Ewing, A, G. Anal. Chem. 1992, 64, 512.
(12) Hayes, M. A.; Kheterpal, I.; Ewing, A. G. Anal Chem. 1993, 65, 2010,
(13) Polson, N. A.; Hayes, M. Anal. Chem, 2000, 72, 1088.
(14) Bush, J. S.; Wing, P.-C.; DeVoe, D. L.; Lee, C. S. Electrophoresis 2001, 22, 3902.
(15) Petsev, D. N. J. Chem. Phys. 2006, 123, 244907.
(16) Daiguji, H.; Oka, Y.; Shirono, K. Nano Lett. 2005, 5, 2274.
(17) Karnik, R.; Fan, R.; Yue, M.; Li, D.; Yang, P.; Majumdar, A. Nano Lett. 2005, 5, 943.
(18) Petsev, D. N.; Lopez, G. P. J. Colloid Interface Sci. 2006, 294, 492.
(19) Rice. C. L.; Whitehead, R. J. Phys. Chem 1965, 69, 4017,
(20) Verwey, E. J. W.; Overbeek, J. T. G. Theory and Stability of Lyophobic Colloids; Elsevier: Amsterdam, 1948.
(21) Qiao, R.; Aluru, N. R. J. Chem Phys. 2003, 118, 4692.
(22) Thompson, A. P. J. Chem. Phys, 2003, 119, 7503.
(23) Karniadakis, G.; Beskok, A.; Aluru. N. Microflows and Nanoflows; Springer: New York, 2005.
(24) Derjaguin, B. V.; Churaev, N. V.; Mullen V. M. Surface Forces; Plenum: New York, 1987.
(25) Debye, P. Phys. Zischr. 1923, 24, 185.
(26) Dukhin, S. S.; Derjaguin, B. V. In Surface and Colloid Science; Matijevic, E., Ed.; Wiley Interscience: New York, 1974; Vol. 7, pp 49.
(27) Hunter, R. J. Zeta Potential in Colloid Science; Academic Press: New York, 1981.
(28) Samson, E.; Marchand, J.; Snyder, K. A. Materials and Structures 2803, 36, 156.
(29) Levine, S.; Marriot, J. R.; Robinson, K. J. Chem. Soc. Faraday Trans 11 1975, 71, 1.
(30) Levine, S.; Marriot, J. R.; Neale, G.; Epstein, K. J. Colloid Interface Sci. 1975, 53, 136.
(31) Morrison, F. A.; Oslerle. J. F. J. Chem Phys. 1965, 43, 2111.
(32) Siwy, Z.; Fulinski, A. Phys Rev Lett 2002, 89, 19103.
(33) Siwy, Z.; Dobrev, D.; Neumann, R.; Trautmann, C.; Voss, K. Appl Phys A 2003, 76, 781.

We claim:

1. A nanofluidic device comprising:
a first fluid reservoir coupled to a second fluid reservoir via a channel having a channel wall;
wherein each reservoir contains an isotonic electrolyte solution; and
wherein the current and fluid flow from the first reservoir to the second
reservoir is controlled by the type of isotonic electrolytic solution in each reservoir.

2. The nanofluidic device of claim 1 wherein the channel width is less than or equal to 1 micrometer.

3. The nanofluidic device of claim 1, wherein the electrolyte solutions in the first and second reservoirs are different.

4. The nanofluidic device of claim 1, wherein at least one of the electrolyte solutions contains monovalent electrolytes.

5. The nanofluidic device of claim 4, wherein the monovalent electrolyte is KCl.

6. The nanofluidic device of claim 1, wherein at least one of the electrolyte solutions contains asymmetric electrolytes.

7. The nanofluidic device of claim 6, wherein the asymmetric electrolyte is MgCl₂.

8. The nanofluidic device of claim 1, wherein at least one of the electrolyte solutions contains symmetric electrolytes.

9. The nanofluidic device of claim 1, wherein an electric double layer forms at the channel wall.

10. The nanofluidic device of claim 9, wherein the channel wall is connected to an electrode.

11. The nanofluidic device of claim 9, wherein the width of the channels is at least four times greater than the thickness of the electric double layer formed at the channel wall.

12. The nanofluidic device of claim 9, wherein the electric double layer formed at the channel wall is about 300 nm thick.

13. The nanofluidic device of claim 9, wherein the electric double layer formed at the channel wall is about 3 nm thick.

14. The nanofluidic device of claim 1, wherein the channels are parallel slit shaped channels.

15. The nanofluidic device of claim 1, wherein the walls of the channels are charged.

16. A method for altering the current conductivity in a nanofluidic device comprising
filling a first reservoir at a first end of a channel in a nanofluidic device with a monovalent electrolyte;
filing a second reservoir at a second end of a channel in a nanofluidic device with an asymmetric electrolyte; and
modulating the potential in a wall of the channel using an electrode.

17. The method of claim 16, wherein the monovalent electrolyte and the asymmetric electrolyte are isotonic.

18. The method of claim 16, wherein modulating the potential in a wall of the channel comprises applying transverse voltage bias.

19. The method of claim 16, wherein the monovalent electrolyte is KCl.

20. The method of claim 16, wherein the asymmetric electrolyte is MgCl₂.
